(19) United States
(12) Patent Application Publication
(10) Pub. No.: US 2010/0223098 A1
(43) Pub. Date: Sep. 2, 2010

(54) Method and Apparatus for Providing Services to Client Groups in a Communication Network

(75) Inventors: Johan Hjelm, Tokyo (JP); Elena Fersman, Uppsala (SE)

Correspondence Address: POTOMAC PATENT GROUP PLLC, P. O. BOX 270, FREDERICKSBURG, VA, 22404, US

(73) Assignee: TELEFONAKTIEBOLAGET L M ERICSSSON (PUBL), Stockholm (SE)

(21) Appl. No.: 12/599,149

(22) PCT Filed: May 28, 2007
(86) PCT No.: PCT/SE2007/000510

§ 371 Date: Nov. 6, 2009

(51) Int. Cl. G06Q 30/00; G06Q 10/00; G06Q 50/00

(52) U.S. Cl. 705/10; 705/14.25

(57) ABSTRACT

A method and apparatus for offering or providing a service to multiple clients in a communication network. A service provisioning unit creates a group profile with common characteristics for a group of clients, e.g. based on user profiles stored in a profile database. A service is then composed that is adapted to the group profile and relevant for the common characteristics in the group profile. A service trigger condition is also defined for the adapted service which controls when the service is to be offered or provided. The service provisioning unit finally offers or provides the adapted service to the client group when it is detected that the service trigger condition is fulfilled.

### TECHNICAL FIELD

The present invention relates generally to a method and apparatus for making services available to a group of clients in a communication network. In particular, the invention is concerned with offering services that are adapted to the interests and needs of the client group.

### BACKGROUND

With the emergence of 3G mobile telephony, new packet-based communication technologies using IP (Internet Protocol) have been developed to support wireless communication of multimedia. For example, communication protocols in GPRS (General Packet Radio Service) and WCDMA (Wideband Code Division Multiple Access) support packet-switched multimedia services, as well as traditional circuit-switched voice calls. New services are also constantly developed for both mobile and fixed users to increase the field of usage for their communication devices. It is also very useful to understand the needs and interests of users in different environments in order to create and offer relevant and potentially interesting services to different users.

A service and service-delivery control architecture called “IP Multimedia Subsystem” (IMS) has been developed by the 3^{rd} Generation Partnership Project (3GPP) as a platform for handling multimedia services and sessions in the packet domain, based on IP transport. Thus, an IMS network can be used to initiate and control multimedia sessions for any fixed or mobile IP enabled communication terminals connected to any type of access networks.

Invoked multimedia services are enabled and executed by various application servers, either servers within the IMS network or external servers controlled by “third party” service providers. The sessions are controlled by various session managing nodes in the IMS network, and a database node HSS (Home Subscriber Server) stores subscriber and authentication data for subscribing clients. IMS is mentioned in this description for illustrative purposes only, although the present invention is not limited to using an IMS network. The advent of IMS has greatly fuelled the development of multimedia-based services.

Among other things, presence services have been introduced involving the publishing of presence data of clients to become available to other clients and applications. Presence data may indicate the characteristics of a client in some respect by basically defining the state or situation of the client and his/her equipment, commonly referred to as “device”. The presence data or client state may include a client status, a device status, the client's location, device capabilities, and other personal client information such as age, sex, interests, profession, previous activities, current mood, etc. Such various characteristics may form a more or less dynamic user profile of the client.

Recently, a concept has also been developed to provide refined or adapted information on communication clients, e.g. to increase the usability of applications for invoked services depending on the client's current situation or behaviour. This concept is generally referred to as the distribution of “context” information, which may be implemented by using similar mechanisms as for the above-described presence services. It is desirable to develop “context-aware” applications and services optimally adapted to the prevailing circumstances. The context information reflecting the client's situation can thus be shared in client groups in the same manner as presence data, or be used to create an optimal service for the client. The process of creating and configuring a service is often referred to as “service provisioning”, which term will be used in the following.

A context server may be used for collecting information on the client by receiving client data from various sources, such as “sensors” or the like adapted to measure or register various variables or the like characterising the current state, status or situation of the client as well as environmental parameters such as ambient light and sounds. For example, sensors may be arranged to measure physical characteristics such as temperature and movements, to register device activities either in the communication device or in the network used, or to register any of the client states mentioned above for presence services. Hence, the above-described context information and the presence data of a client actually reflect the behaviour of that client in some respect, e.g. in terms of device usage and geographic whereabouts.

The currently available mechanisms for providing presence data and context data for a client of interest to a requesting party, are illustrated schematically in FIG. 1. The client of interest 100 is a user of a mobile terminal T, or a software agent implemented therein, for which various event publications are sent to a presence server 102, either from the terminal T itself or from the network used, not shown. The presence server 102 may in turn send notifications to the requesting party 104, e.g. a subscribing client, regarding current presence data.

In addition or alternatively, one or more sensors 106 may be arranged as described above to provide raw context data to a context server 108, the data being received and stored in a context storage unit 108a. The shown sensors 106 may also represent functions reflecting client activities in the terminal T or in the network. Moreover, existing routines in the communication network for, e.g., generating call data records for clients can also be used to provide context data.

The stored raw data may then be processed and refined in a context refiner 108b by applying predefined refining rules 108c on the raw data, in order to derive or calculate new refined context information from the raw data. The predefined refining rules 108c may include algorithms or the like that calculate certain parameters, draw conclusions or create compilations from the raw data. The refined context can then be distributed to the requesting party 104 according to conventional routines, not described here further. The requesting party 104 may obtain a subscription to receive context information from the context server 108 on a more or less continuous basis, i.e. in a similar manner as for the presence data. The requesting party 104 may also be an application server capable of provisioning context-aware services for individual clients based on received context information.

Typically, the context information pertains to an individual client having a certain user profile of characteristics as defined by his/her settings, preferences and current context. However, a client may also belong to an established group of clients having an aggregated group profile with characteristics shared by its members. For example, members of a family may have individual contexts while the family may have a common context with an aggregate profile shared by its members, whereas another group specifically interested in, e.g., football may have a completely different profile.

WO 06/115442 discloses a mechanism where the particular needs of a requesting group of clients can be met by providing relevant context information regarding a specific object of interest, which information has been adapted to particular interests and needs of the group. In this solution, a “customised” refining rule can be created for the requesting group defining conditions when requesting for refined context information. An aggregated context function creates an aggregated context for the group by collecting individual context data for each of the group's members, in order to create the customised refining rule valid for the group. The customised refining rule is sent to a context server (which may be configured basically as the context server 108 in FIG. 1) as an adapted request for refined context information on the object of interest. The context server then refines raw context data according to the customised refining rule and delivers the refined context data in response to the request.

As described above, mechanisms are available today for provisioning context-aware services involving content delivery to individual clients depending on their current context and dynamic user profile. For example, information and advertisements can be offered to clients depending on their characteristics such as age, sex, interests and preferences, and in certain situations such as when present in a specific area at a certain time of day, week or season.

It is also possible for groups of clients to receive group-adapted services in a request-triggered manner as described in above-mentioned WO 06/115442. However, the wanted service must then be defined and requested by the members of a formed group. IMS generally supports services involving delivery of personalised content from service and content providers to individual clients or to ad-hoc groups of clients, in the manner described above.

Today, it is not possible to address multiple clients with adapted service offerings as initiated by a service provider. Thus, there is no mechanism available as yet to find plural clients with common interests and needs in a communication network, and to offer services of particular relevance to those clients in certain situations. This fact has been identified as a problem, and the prospect of creating and providing potentially interesting services for multiple “similar” clients, e.g. at discounted prices or with other offerings, can therefore not be exploited.

### SUMMARY

The object of the present invention is to address the problems outlined above. It is thus generally desirable for service and content providers to be able to offer attractive and relevant services to multiple clients with common interests and needs in a communication network. This object and others are achieved primarily by providing a method and apparatus for offering or providing adapted services to multiple clients in a communication network.

In the inventive method, a group profile is created with common characteristics for a group of clients, and a service is composed that is adapted to the group profile and relevant for the common characteristics in the group profile. Further, a service trigger condition is defined for the adapted service which controls when the service is to be offered or provided, and the adapted service is offered or provided to the clients in the client group when it is detected that the service trigger condition is fulfilled.

In the inventive apparatus, a service provisioning unit comprises a group profile creating unit adapted to create a group profile with common characteristics for a group of clients, and a service composing unit adapted to compose a service that is adapted to the group profile and relevant for the common characteristics in the group profile, and to define a service trigger condition for said adapted service to control when the adapted service is to be offered. The service provisioning unit further comprises a service trigger detecting unit adapted to detect when said service trigger condition is fulfilled, and a service offering unit adapted to offer or provide said adapted service to the clients in the client group when it is detected that the service trigger condition is fulfilled.

Further preferred features and benefits of the present invention will become apparent from the detailed description below.

### BRIEF DESCRIPTION OF THE DRAWINGS

The present invention will now be described in more detail by means of preferred embodiments and with reference to the accompanying drawings, in which:

FIG. 1 is a schematic block diagram illustrating mechanisms in a communication network for providing presence data and context data for a client to a requesting party, according to the prior art.

FIG. 2 is a schematic block diagram illustrating a procedure for offering a service to multiple clients in a communication network by means of a service provisioning unit, according to one embodiment.

FIG. 3 is a flow chart illustrating the basic steps for offering a service to a group of clients, according to another embodiment.

FIG. 4 is a schematic block diagram illustrating a service provisioning unit in more detail, according to yet another embodiment.

FIG. 5 is a signalling diagram illustrating a procedure where a service is offered and delivered to a group of clients, according to yet another embodiment.

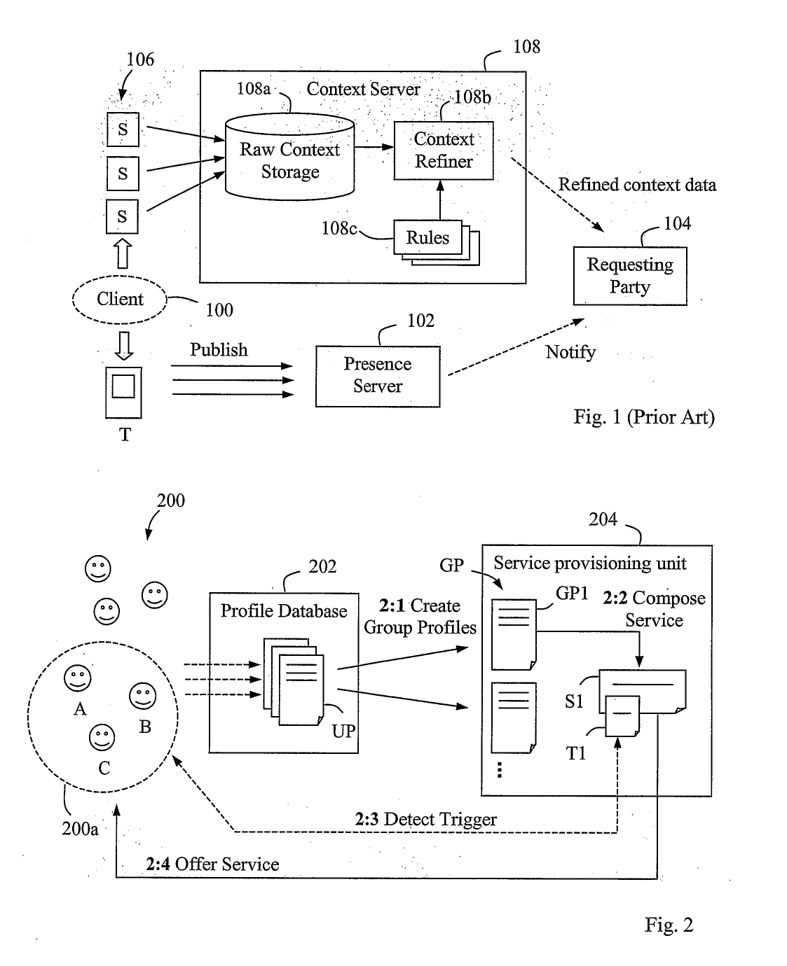

### DETAILED DESCRIPTION

Briefly described, the present invention provides a solution for offering or providing a service adapted to a group of clients in a communication network, where the clients in the group have common characteristics in some respect. The offered service can then be adapted to meet specific needs or interests of the clients in the group in particular prevailing circumstances, such as a client context. The offered service may involve delivery of multimedia content, e.g. in order to sell content, advertise, announce, entertain, or provide information. In this description, “offering or providing” a service indicates that the service may involve offering a product or piece of information or content, e.g. in the manner of an advertisement or the like, or the actual delivery of the product, information or content.

In this solution, a group profile is created for the client group containing their common characteristics. A profile database storing user profiles of a multitude of clients in the communication network, may be utilised for creating the group profile by identifying the clients in the profile database as having the common characteristics. Alternatively, the group profile may be created upon request from a client to form the group, or it may be created for an already existing group of clients.

The group profile thus contains the common characteristics for the clients in the group which may comprise personal data such as age, sex, interests, preferences and settings, as well as context-related data such as the location. The common characteristics may further include a previous behaviour of the clients. For example, a group profile may be created for a group of clients having utilised a particular service previously, e.g. at a certain location and/or time or with a certain frequency of usage. The group profile may be created further based on a precondition, e.g. a sufficient number of clients with certain characteristics must be present in a certain area.

As the group profile has been formed, a service is composed that is adapted to the group profile in some respect relevant for the common characteristics therein. A service trigger condition associated with the composed service is also defined, which must be fulfilled before the service is offered or provided to the clients in the group. The service trigger condition may stipulate that some context-related circumstances must occur before the service is triggered. For example, the service trigger condition may be that at least a predetermined number of the clients in the group are present in a specific area at a certain time of day, week or season. Thus, whenever it is detected that the service trigger condition is fulfilled, the adapted service can be offered or provided to the client group.

FIG. 2 illustrates schematically an exemplary procedure for offering or providing a service from a service provisioning unit to multiple clients in a communication network, according to one feasible embodiment. The term “service provisioning unit” will be used throughout this description to generally represent a unit or function that is adapted to provision and offer or provide any services to clients. The service provisioning unit may be implemented in an application server or the like and may be operated or controlled by a service provider or content provider, for technically creating and offering or providing adapted services to groups according to the described embodiments.

In FIG. 2, a plurality of clients 200 are present in a communication network and their individual user profiles UP are maintained in a profile database 202, which may be implemented in a central database node such as the above-mentioned HSS node or a “Presence and Group Manager PGM”, both being logic entities defined for IMS. A user profile can thus be more or less dynamic and contains various characteristics such as personal data as well as settings, preferences and context-related data.

It is assumed that the profile information lodged in profile database 202 is available, at least partly, to a service provisioning unit 204 having various functional units which are not specifically shown here. A more detailed embodiment of a service provisioning unit will be described later in connection with FIG. 4. Thus, FIG. 2 merely illustrates schematically how the service provisioning unit 204 may operate in the context of the present invention. The service provisioning unit 204 may be implemented to cover a more or less limited area in the communication network.

In a first illustrated step 2:1, group profiles GP are created in the service provisioning unit 204, e.g. by identifying a plurality of clients in the profile database 202 as having common characteristics in their user profiles UP, where the group profiles are built from those common characteristics. Thus, the individual user profiles UP in profile database 202 may be analysed by some logic means not described here further, to find clients with common characteristics.

A group profile may be created based on a precondition for when the group is considered to be “active”. For example, when a sufficient number of clients with certain characteristics are detected to be present in a certain area, these clients may automatically constitute an active group for which a group profile is created. As mentioned above, the group profile may alternatively be created when a client requests to form the group, or it may be created for an already existing group of clients.

In one possible implementation, the group profiles GP may be created and maintained by a “Group Management Server, GMS” which is another logic entity defined for IMS, which then provides the group profiles to an application server or the like. In this description, the function of creating group profiles GP is assumed to reside in the service provisioning unit 204, at least logically, although the present invention is not limited thereto.

In the example of FIG. 2, a group of clients 200a is formed by identifying the clients A, B and C as having common characteristics in their user profiles UP, and a group profile GP1 is created for those clients with their common characteristics. Then, an adapted service S1 is created in a step 2:2, that is specifically adapted to the formed group profile GP1 in order to meet various needs and interests that can be derived from the characteristics in group profile GP1. A service trigger condition T1 is also defined for the composed service S1, which controls when the service is to be offered or provided to the clients in the group 200a.

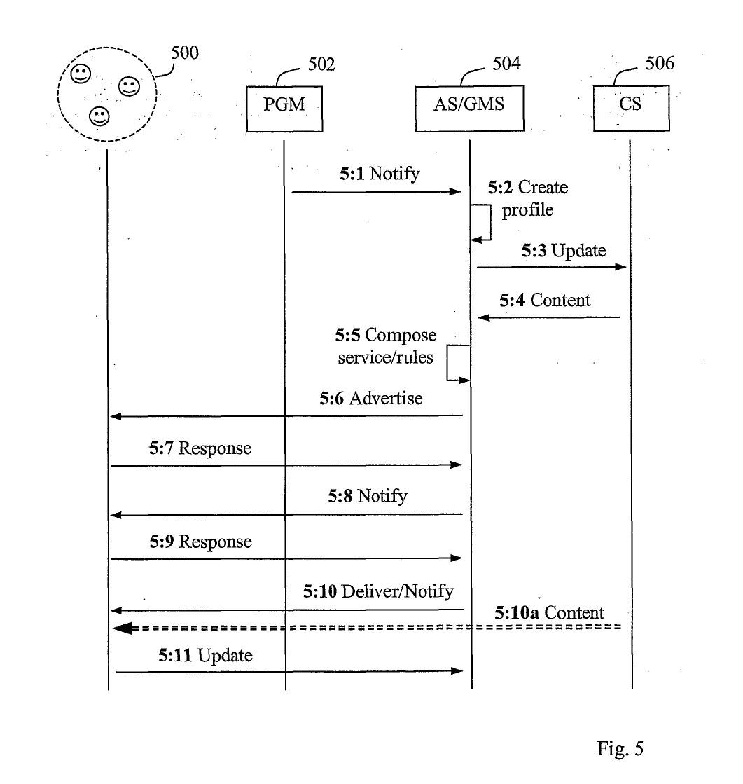

For example, the group 200a may have been formed by identifying that clients A, B and C have a common interest in music, and a service S1 may then be composed that provides information on musical events at locations reasonably close to where the clients are currently present. The service trigger condition T1 may stipulate that at least some of the clients in the group are present in a certain area on a Saturday or Sunday, which must be fulfilled before providing current musical event information to those clients present in the area. The service may further involve a conditional offer of a discounted purchase. For example, discounted admission prices may be offered to the musical events, if a sufficient number of the clients decides to accept the offer. An example of handling a service involving such a conditional offer will be described later with reference to FIG. 5.

Thus, the service provisioning unit 204 comprises a logic function that is capable of detecting when the service trigger condition T1 is fulfilled, e.g. by monitoring the clients, in order to launch the composed service S1. Monitoring the clients with respect to the service trigger. condition can be performed in different ways. For example, the service provisioning unit 204 may subscribe to profile updates from the profile database 202 (e.g. PGM), such that database 202 notifies whenever clients in the group change a context or situation reflected in their user profiles in a manner relevant to the service trigger condition. Alternatively, service provisioning unit 204 may query the database 202 at regular intervals, or a “watcher” function may be implemented to trigger as soon as a certain monitored threshold value is exceeded, or the like. A client monitoring function, or “service trigger detecting unit”, may be implemented within the service provisioning unit 204 or as a separate logic node communicating with the service provisioning unit 204 in a suitable manner.

In this example, the service trigger condition T1 is generally detected to be fulfilled in a step 2:3. The service trigger condition T1 may thus be detected by monitoring the clients in the group 200a and/or their current context in some respect, depending on the nature of the trigger condition. For example, if the service trigger condition requires that the clients are present in a predetermined area, the location of the clients in the group is monitored. Basically, any context-related circumstances required by the trigger condition can be monitored in a suitable manner. Finally, the service S1 is offered or provided to one or more clients in the group upon detecting that the service trigger condition T1 is fulfilled, in a final shown step 2:4.

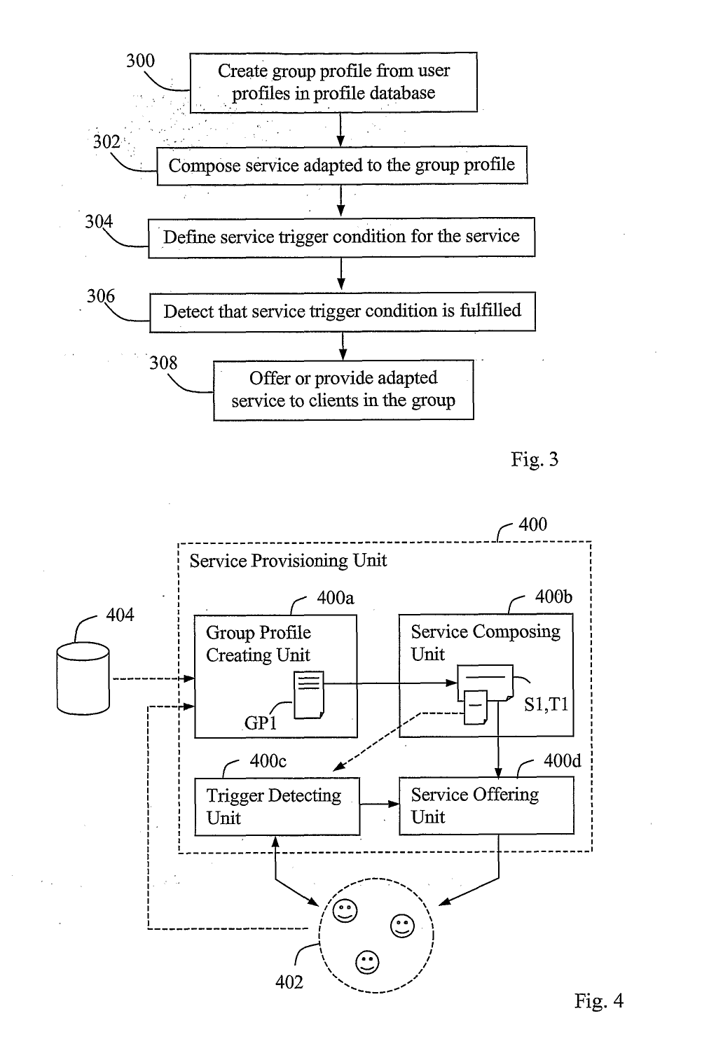

FIG. 3 illustrates a flow chart comprising steps in a procedure for offering or providing a service adapted to a client group, according to another embodiment. The steps are basically executed by a service provisioning unit or the equivalent, e.g. according to the example of FIG. 2. In a first step 300, a group profile is created for a group of clients having common characteristics, e.g. as identified from user profiles in a profile database or upon request from a client. This step basically corresponds to step 2:1 in FIG. 2.

In a next step 302, a service is composed that is adapted to the group profile, by taking the common characteristics into account in order to meet specific needs and interests of the clients in the group. In a further step 304, a service trigger condition is also defined for the service composed in step 302, which controls when the service is to be offered or provided to the clients. Steps 302 and 304 basically correspond to step 2:2 in FIG. 2.

The clients in the group and/or their current context may then be monitored with respect to the service trigger condition, not shown here as a distinct step. As explained above in connection with step 2:3, the monitoring may be performed in different ways without limiting the general scope of the present invention, e.g. depending on the implementation and the nature of the trigger condition, not further described here. Then in a following step 306, basically corresponding to step 2:3 in FIG. 2, it is detected that the service trigger condition is fulfilled. As a result, the adapted service is offered or provided to one or more clients in the group, in a final shown step 308, basically corresponding to step 2:4 in FIG. 2.

FIG. 4 is a block diagram illustrating a service provisioning unit 400 in more detail, according to yet another embodiment. A group of clients 402 is also shown having common characteristics in some respect, as well as a user profile database 404 hosting individual user profiles for a multitude of clients, including the shown clients 402. It should be noted that the service provisioning unit 400 is merely shown schematically in terms of functional units 400a-d which are named here to indicate their basic functions. In practice, the shown units 400a-d can be implemented in different ways not limited to the shown structure.

The service provisioning unit 400 comprises a “group profile creating unit” 400a which is adapted to create a group profile GP1 for the client group 402, e.g. identified as having common characteristics from their user profiles in profile database 404, or upon request from a client, as illustrated by the dashed arrows pointing to unit 400a. A function of automatically identifying clients with common characteristics, not shown, may be implemented preferably in the service provisioning unit 400, although it is also possible to implement this function in the profile database 404.

The service provisioning unit 400 further comprises a “service composing unit” 400b adapted to compose a service S1 that is adapted to the group profile GP1, by taking the common characteristics therein into account. For example, composing an adapted service may include selecting a service from a set of predefined services, that is deemed suitable for the needs and interests of the client group. Service composing unit 400b is also adapted to define an associated service trigger condition T1 controlling when the composed service is to be offered or provided to the clients. Service composing unit 400b contains a suitable software-based logic configured to perform the above-described service composing and trigger defining functions, not described here further.

The service provisioning unit 400 further comprises a “trigger detecting unit” 400c adapted to detect when the service trigger condition is fulfilled e.g. by monitoring the clients in the group 402 and/or their current context with respect to the service trigger condition. Some examples of how to implement this detecting function has been described above in connection with. FIGS. 2 and 3.

The service provisioning unit 400 further comprises a “service offering unit” 400d adapted to offer or provide the adapted service to one or more clients in the group. 402 whenever the trigger detecting unit 400c detects that the service trigger condition is fulfilled.

As mentioned above, a service may be composed that involves a conditional offer to a group of clients for a discounted purchase, where a sufficient number of the clients must accept the offer in order to obtain the discount or reduction, referred to as a quantity discount. A possible realisation of a service involving such a conditional offer will now be described with reference to a signalling diagram in FIG. 5, according to yet another embodiment.

The shown signalling procedure in FIG. 5 involves a group of clients 500 in a communication network, a PGM server 502 hosting user profiles for the individual clients in the group, an application server/group management server AS/GMS 504 in which functions of the above-described service provisioning unit are implemented, and a content server CS 506 controlled by a service provider. The various messages described below may be communicated by means of the Session Initiation Protocol SIP used for IMS, e.g. over an IMS node for session control called S-CSCF (Serving Call Session Control Function), not shown here, although the present embodiment is not limited thereto.

When the client group 500 is established as active, e.g. in the manner described above, a service can be offered and delivered to the clients as follows. In a first step 5:1, the PGM server 502 notifies the AS/GMS. node 504 with a list of the members in the group 500 and their user profiles. The AS/GMS node 504 then creates a group profile (which is stored in the GMS) with characteristics common for the clients, based on the received user profiles, in a next step 5:2. If the group already exists, the group profile may also be based on its old existing group profile, if present.

In this example, the CS node 506 stores a set of predefined advertisements and rules dictating various conditions and provisions associated with the advertisements. In a following step 5:3, the AS/GMS node 504 requests for an advertisement for the group from the CS node 506 in a profile updating message. In step 5:3, the AS/GMS node 504 may send the updated group profile, or simply notify the CS node 506 that it is time to fetch (or synchronise) the new profile from a profile database. CS node 506 then selects a relevant advertisement for the group and responds by sending content of the selected advertisement and one or more associated rules defined for the advertisement to AS/GMS node 504, in a next step 5:4.

In this example, the advertisement specifies a quantity discount offer where a product is offered to a discounted price, provided that a sufficient number of clients agree to purchase the product, as a rule for the advertisement. Further rules may also be defined for the advertisement, such as rules for charging details, delivery methods, etc.

In a further step 5:5, the AS/GMS node 504 composes an adapted service according to the received advertisement and rules, e.g. by building suitable content descriptions for the service in an XML format. Then, the AS/GMS node 504 basically offers the adapted service by sending the advertisement to all group members 500, e.g. as XML descriptions, in an SIP message, in a step 5:6.

The next step 5:7 illustrates that one of the clients in the group responds by indicating his/her interest in purchasing the product at reduced price, according to the offered quantity discount. The AS/GMS node 504 then informs, the other clients in the group 500 on the fact that one client has accepted the offer, in a further step 5:8. As a result, further clients in the group may likewise respond and indicate their interest in purchasing the product, until the requested number of clients finally has accepted the offer, which is generally indicated by a step 5:9. Then, the offered product can generally be delivered, or, at least notified for delivery, to the accepting clients, in a step 5:10. For example, a voucher or the like may be sent to the clients providing the discount. This step may also involve delivery of the product or a corresponding voucher as content from the CS node 506, as indicated by a dashed step 5:10a.

Finally, the executed purchase may be registered in the group profile, if required, by sending a profile update massage from the clients to the AS/GMS node 504, in a last shown step 5:11.

In the example above, it is possible that a client in the group may want to purchase more than one item of the advertised product. In that case, the client can send the response of step 5:7 (or step 5:9) to AS/GMS 504 more than once to indicate how may items he/she wants to buy. A threshold may be set as a rule for how many times a client is allowed to indicate a wanted purchase. A default interface may also be implemented in AS/GMS 504 adapted to query the client when responding more than once, to avoid cheating and denial-of-service attacks against the service.

When informing the clients 500 that one more client has accepted the offer, as shown in step 5:8, and/or on how many clients have accepted the offer so far, the AS/GMS node 504 may send notifications to the clients 500 in SMS or MMS messages or by any other suitable means. As soon as the necessary threshold is reached, the group members are notified and a discount voucher may be stored on IMS accounts of the accepting clients, to be used for, e.g., online shopping. These vouchers may also have an expiry date, e.g. dictated by the associated rules described above.

While the invention has been described with reference to specific exemplary embodiments, the description is generally only intended to illustrate the inventive concept and should not be taken as limiting the scope of the invention. The present invention is defined by the appended claims.

1. A method in a service provisioning unit of offering or providing adapted services to multiple clients in a communication network, comprising the following steps:
creating a group profile (GP) for a group of clients by identifying clients having common characteristics in their individual user profiles (UP) maintained in a user profile database, wherein the group profile is created with the common characteristics of said clients,
composing a service that is adapted to the group profile and relevant for the common characteristics in the group profile,
defining a service trigger condition for said adapted service which controls when the service is to be offered or provided to the clients in the group, wherein the clients in the group and/or their current context are monitored with respect to the service trigger condition, and
offering or providing said adapted service to the clients in the client group when it is detected that the service trigger condition is fulfilled.

2. A method according to claim 1, wherein said common characteristics include at least one of: age, sex, interests, preferences and settings.

3. A method according to claim 1, wherein the group profile is created based on a precondition such as when a sufficient number of clients with certain characteristics are present in a certain area.

4. A method according to claim 1, wherein the adapted service is specifically adapted to the formed group profile by meeting various needs and interests derived from the common characteristics in the group profile.

5. A method according to claim 1, wherein the service trigger condition stipulates that a predefined client context must be fulfilled.

6. A method according to claim 5, wherein the predefined client context comprises environmental parameters including at least one of: location, the weather, the time of day, week and/or season, and ambient light and sounds.

7. A method according to claim 1, wherein the service involves a conditional offer of a discounted purchase, if a sufficient number of the clients agree to accept the offer.

8. A service provisioning unit (400) for offering or providing adapted services to multiple clients (402) in a communication network, comprising:
a group profile creating unit (400a) adapted to create a group profile (GP) for a group of clients by identifying clients having common characteristics in their individual user profiles (UP) maintained in a user profile database, wherein the group profile is created with the common characteristics of said clients,
a service composing unit (400b) adapted to compose a service that is adapted to the group profile and relevant for the common characteristics in the group profile, and to define a service trigger condition for said adapted service to control when the adapted service is to be offered to the clients in the group,
a service trigger detecting unit (400c) adapted to detect when said service trigger condition is fulfilled by monitoring the clients in the group and/or their current context with respect to the service trigger condition, and
a service offering unit (400d) adapted to offer or provide said adapted service to the clients in the client group when it is detected that the service trigger condition is fulfilled.

9. A service provisioning unit according to claim 8, wherein said common characteristics include at least one of: age, sex, interests, preferences and settings.

10. A service provisioning unit according to claim 8, wherein the group profile creating unit is further adapted to create the group profile based on a precondition such as when a sufficient number of clients with certain characteristics are present in a certain area.

11. A service provisioning unit according to claim 8, wherein the adapted service is specifically adapted to the formed group profile by meeting various needs and interests derived from the common characteristics in the group profile.

12. A service provisioning unit according to claim 8, wherein the service trigger condition stipulates that a predefined client context must be fulfilled.

13. A service provisioning unit according to claim 12, wherein the predefined client context comprises environmental parameters including at least one of: location, the weather, the time of day, week and/or season, and ambient light and sounds.

14. A service provisioning unit according to claim 8, wherein the service involves a conditional offer of a discounted purchase, if a sufficient number of the clients agree to accept the offer.
